(19) United States
(12) Patent Application Publication
(10) Pub. No.: US 2005/0122956 A1
(43) Pub. Date: Jun. 9, 2005

(54) Method for establishing a telecommunication link and a telecommunication network

(75) Inventors: Ansgar Bergmann, Valbonne (FR); Andreas Schenke, Bonn (DE); Bernd Gosele, Bonn (DE); Martin Lorang, Bonn (DE); Karl Eigler, Wachtberg (DE); Thomas Witthaut, Bonn (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: IP2H AG

(21) Appl. No.: 10/848,892

(22) Filed: May 19, 2004

Related U.S. Application Data
(63) Continuation of application No. PCT/DE02/04142, filed on Nov. 7, 2002.

(30) Foreign Application Priority Data
Nov. 20, 2001 (DE) 101 56 572.0
Dec. 11, 2001 (DE) 101 60 766.0
Jun. 24, 2002 (DE) 102 28 209.9

(51) Int. Cl. H04L 12/28

(52) U.S. Cl. 370/351

(57) ABSTRACT

A method and a telecommunication network for establishing a telecommunication link between a first and a second subscriber (A, BK) in a telecommunication network, in particular between two devices that are suitable for communicating, with addresses being assignable to the subscribers (A, BK). To provide a reliable telecommunication link between subscribers (A, BK) in the telecommunication network, a switching unit (TR) assigns to the second subscriber (BK) a predetermined number of addresses before establishing the link. The switching unit (TR) then establishes link, and the second subscriber (BK) uses at least one of the assigned addresses when the link is established.

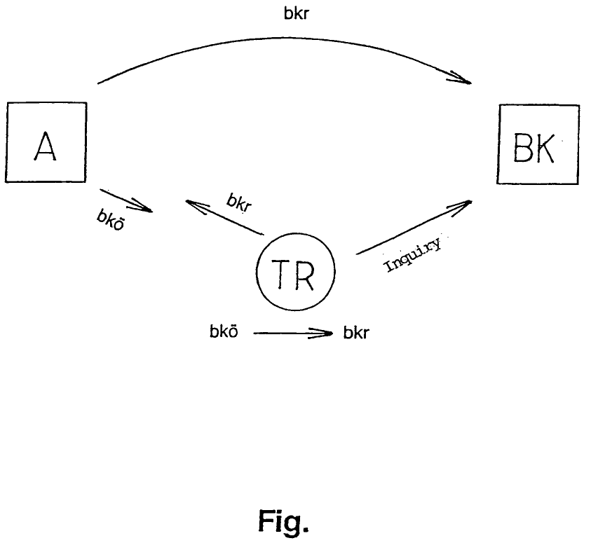

### CROSS REFERENCE TO RELATED APPLICATION

The present application is a continuation of international application PCT/DE02/04142, filed 7 Nov., 2002, and which designates the U.S. The disclosure of the referenced application is incorporated herein by reference.

### BACKGROUND OF THE INVENTION

The present invention relates to a method for establishing a telecommunication link between a first and a second subscriber in a telecommunication network, in particular between two devices that are suitable for communicating, wherein addresses can be allocated to the subscribers. Furthermore, the present invention relates to a telecommunication network for establishing a telecommunication link between a first and a second subscriber, in particular between two devices that are suitable for communicating, with the addresses being assignable to the subscribers.

In known telecommunication networks, addresses and/or identifiers are used for establishing a telecommunication link and for routing. In this connection, the term “routing” could mean the functionality of transmitting information from one network node to another network node in the telecommunication network, if need be, via intermediate nodes.

In the known telecommunication networks, addresses and/or identifiers are transmitted in plain language text. The addresses can be assigned to subscribers or devices. For example, IP addresses are used, which are subscriber-specific or device-specific. Furthermore, Ethernet addresses are used, which are device-specific. The addresses are essential in the establishment of a telecommunication link between two subscribers or between two devices that are suitable for communicating.

Typically, the telecommunication networks are at least partially public in the meaning that network nodes of the telecommunication networks are accessible to a large and indeterminable group of people. In this connection, there exist extensive possibilities of suitably operating individual network nodes, providing them with functions, configuring, and/or manipulating them.

The normally unencrypted transmission of addresses and/or identifiers, which can be allocated to subscribers or devices, enables a series of attacks on the security of the subscribers or users, or substantially contributes to such attacks. In this connection, the following attacks are possible:

(a) Localization: an attacker may monitor data streams and deduce the location of a subscriber or user. For purposes of localizing, the attacker may send messages directed to an address of the subscriber or user, which the network node of the subscriber or user answers in accordance with the protocol automatically upon receipt.

(b) Tracing: in accordance with the method described under (a), an attacker is able to trace the movement of a subscriber or user.

(c) The data streams allocated to the subscriber or user can be identified as such and be purposefully attacked, for example, for purposes of rerouting, canceling, corrupting, or tapping.

(d) It is possible to generate false messages that are directed to the subscriber or user.

Previously used and/or known security methods are suitable for protecting the data of the user. In this connection, one applies methods for encoding, protecting the integrity, and/or authenticating. However, address and/or identification data remain unencrypted. Under circumstances, addresses and/or identifiers are authenticated, though, and their integrity is protected. However, this can be only examined by the end points of the telecommunication link, since it is necessary to exchange to this end a so-called “security association.”

Yet, in the end, the attacks described under (a) and (b) continue to be possible, and the attacks described under (c) and (d) are facilitated.

For a better illustration, the following attack scenario could exist: a user has a PDA—personal digital assistant—with a WLAN card. This WLAN card has a permanent Ethernet address, which is repeatedly automatically transmitted in plain language text in accordance with the protocol. It is likewise possible to cause with suitable messages the PDA to transmit the IP address automatically. With that, an attacker is able to localize without great efforts the user or subscriber in public places, airports, railroad stations, or the like.

For a better and clear understanding of the present invention, some of the used terminology is explained in the following:

Telecommunication network: A telecommunication network means a system, in which devices may have the possibility of transmitting information directly to other devices, i.e., without the use of additional devices. In this connection, one may use in the system always the same transmission technology, or apply different transmission technologies. The applied transmission technologies may use, for example, radio transmission, light wave transmission, or other transmissions. Whether two devices are able to communicate with each other directly, may depend on factors, which change with time, for example, by the movement of the devices, or by changes in the transmission paths and/or transmission characteristics.

Network nodes: Communicating devices that participate in a communication network can be called network nodes.

Addresses: In a telecommunication network, different types of addresses are used, which can be differentiated as follows:
Local addresses: Local addresses mean addresses, which are locally used, for example, between network nodes that are able to communicate directly with one another. More generally, they are addresses, which are used in an area of the telecommunication network, but in general not in an end-to-end communication, unless this end-to-end communication is likewise local. A local address is not used for routing. Typically, a routing address is locally imaged on a local address. Local addresses are typically used in protocols of the layer 2. Examples of local addresses are Ethernet addresses. It is currently common to assign these in a device-specific manner.
Routing addresses: Routing addresses mean addresses that are used for routing, i.e., for establishing end-to-end communication paths in a telecommunication network. In this connection, it is typical to use routing tables that are managed in the network nodes. Typically, routing addresses are used in protocols of the layer 3. Examples of routing addresses are IP addresses.
Topological addresses: In the present application, topological addresses stand for addresses which allow a network node to determine whether an adjacent node is better located relative to a destination node than the node itself. The determination is based on a basic quantity T of possible topological addresses and a screening method, which determines, when applied to triples (a, b, c) of possible topologoical addresses, whether a is better located relative to c than b. Examples of topological addresses are geographic coordinates, with a being located in better relationship with c than b, when the distance from a to c is smaller than that from b to c. A further example of topological addresses are the coordinates that were introduced by WO 97/50195 with the therein disclosed screening method. Under certain preconditions, topological addresses permit routing without routing tables.
Identification addresses: In the present application, they denote addresses, which are used to identify, network nodes, or users, or subscribers. Identification addresses often contain a part, which is used as routing address—for example, to a suitable server.
Public addresses: In the present application, these denote identification addresses, which are publicly known. Examples are telephone numbers and DNS (domain name system) addresses.

Addresses of one address type may pertain to several of the above-described types, for example, a telephone number is typically used at the same time as identification address, public address, and routing address.
Based on the above-described problems, it is an object of the present invention to provide a method for establishing a telecommunication link and a telecommunication network of the initially described type, which permits a secure telecommunication link between subscribers in the telecommunication network.

### SUMMARY OF THE INVENTION

The foregoing object and other advantages are accomplished both by a method for establishing a telecommunication link and a telecommunication network, wherein before establishing the link, a switching unit allocates to a second subscriber a predetermined number of addresses. The establishment of the link is then switched by the switching unit, and the second subscriber uses at least one of the assigned addresses during the establishment of the link.

In accordance with the invention it has been found that the possible alternative use of several addresses makes it difficult or impossible to correlate the used address to a subscriber. To this end, a switching unit allocates to the second subscriber a predetermined number of addresses, before the link is established. The second subscriber can use these addresses substantially unrestricted. Furthermore, the establishment of the link is subsequently switched by the switching unit. The switching unit is able to establish the correlation between the second subscriber and the addresses allocated to this subscriber. Within the scope of the method according to the invention, the second subscriber uses at least one of the allocated addresses when establishing a link.

The first subscriber is unaware of the correlation between the allocated addresses and the second subscriber. Consequently, the method of the invention and the telecommunication network of the invention specify a method and a telecommunication network that permit a secure telecommunication link between subscribers in the telecommunication network,

With respect to a particularly high degree of security, the addresses could be made anonymous. This means, the addresses do not show—at least at a first glance—any relations to the second subscriber.

Concretely, the addresses could be managed by the switching unit. The switching unit could manage the addresses of several subscribers. The addresses could be in particular routing and/or local addresses. Concretely, the addresses could be IP and/or Ethernet addresses.

While the link is being established, the second subscriber could use at least one tuple of routing and local addresses. However, it is also possible to use a plurality of such tuples at the same time.

In a simple manner, the switching unit could be a network node of the telecommunication network. Yet, the function of the switching unit could be distributed over a plurality of network nodes of the telecommunication network. In this connection, one could predetermine a kind of division of labor among the network nodes.

In practice, a provider could offer the use of anonymized addresses. In this connection, the provider could manage a predetermined number of addresses, which pertain to address types used in a communication network. The provider could operate a network node, which is called a “subscriber register (TR).” This network node could implement database functionalities, cryptological functions, and specific protocols. The function of this subscriber register could be distributed over several network nodes, thereby realizing a distributed system as switching unit or subscriber register.

Subscribers who have been assigned a suitable number of addresses by a switching unit, change the used routing addresses and local addresses by methods, which make it very difficult or impossible to correlate the used routing addresses and local addresses, or to associate used routing addresses and local addresses with a subscriber.

In particular, with respect to a first-time application of the method in the case of a second subscriber, the second subscriber could execute an initialization procedure, before the link is established. In this process, it would be possible to set up at the second subscriber within the scope of the initialization procedure, functions, parameters, software, firmware and/or hardware, which are required for a communication and/or an implementation of a cryptological function between the second subscriber and the switching unit. In a particularly simple manner, the functions, parameters, software, firmware, and/or hardware could be set up by the switching unit. Within the scope of the initialization procedure, the switching unit could be used to allocate to the second subscriber before establishing the link, at least one initial address for at least one type of address. The initialization could be performed such that confidentiality remains ensured.

In a particularly simple manner, the switching unit could implement the allocation of addresses to the second subscriber within the scope of the initialization procedure.

For a further simplification of the method, at least parts of the parameters, software and/or firmware could be installed on a hardware component. Such a hardware component could communicate with the second subscriber via a definable interface. In a particularly practical manner, the hardware component could be an IC card, namely a card with an integrated circuit.

In practice, a subscriber who wants to use a network node in a secured way, could thus have the switching unit initialize this network node. To this end, the subscriber could become registered with a provider of the switching unit and be considered a subscribed user. A correspondingly initialized network node could then be called a subscribed network node, which can be operated by the method of the present invention.

Within the scope of the method according to the invention, the subscriber or network node could use in successive time intervals a routing address and a local address that are each assigned by the switching unit. Previously, the switching unit has assigned these addresses within the scope of, for example, the initialization. In this case, a secured communicating relation can be present between the switching unit and the subscriber.

With respect to a safe function and saving of storage space, the second subscriber could remove the used address or addresses from the allocation. For security reasons, used addresses should be used only one time or few times.

In the following, the functions executed by the second subscriber could also be implemented preferably automatically by one or more network nodes, one module, or more modules, or a device of the network node.

As soon as the number of addresses still remaining with the second subscriber is used up or falls below a predetermined quantity, the second subscriber could request new addresses from the switching unit. The request could also automatically occur by the network node, or a module, or a device of the network node. The assigned quantity could be predetermined by the switching unit, and it could randomly vary between predetermined maximum and minimum values. For security reasons, such an allocation of the addresses could occur within the scope of a secure link.

A change of the addresses by the second subscriber could occur in accordance with different procedures or on different conditions. For example, the second subscriber could change the used address or addresses within the scope of its activation. In this process, the change could occur exactly at the time, when the subscriber is activated. As an alternative or in addition thereto, the second subscriber could change the used address or addresses after completing a communication.

The second subscriber could also change the used address or addresses within the scope of the transition from the connected to the disconnected state. In other words, the change could occur during the transition or simultaneously with the transition from the connected to the disconnected state depending on the respective case of application.

As a further alternative, the second subscriber could change the used address or addresses after a predetermined time interval.

As long as the subscriber or network node is activated, but not connected, it could maintain the use of a routing address and a local address for a predetermined duration, which could randomly vary between a minimum and a maximum duration that are predetermined by the switching unit. Basically, the subscriber or network node is designated connected, when it is in an end-to-end communication with one or more other network nodes, and/or functions as a relay for an end-to-end communication.

In a further alternative application, the second subscriber could switch—before the change—within the scope of changing used address or addresses to the disconnected state after a predetermined time interval. Only then could the change of the address or addresses occur. The predetermined time interval could randomly vary within limits that are predetermined by the switching unit. In other words, the subscriber or network node will switch over to the disconnected state, when it is longer connected than a predetermined duration. This duration could randomly vary within limits that are predetermined by the switching unit. Only then could a change of the used routing address and local address occur. To not interrupt a link as a whole, it would be possible, if need arises, to use two or more addresses parallel, so that a link is maintained via a different address also during a transition to a disconnected state with respect to one address. In other words, the second subscriber could use at the same time, within the scope of the link, a plurality of addresses or tuples of addresses.

More specifically, in a preferred method, the subscriber or network node could simultaneously use several tuples of assigned routing addresses and local addresses and thus conceal the change of addresses. In this case, each communication will be tied to a tuple of an assigned routing address and an assigned local address. In this preferred method, communications will be completed, when the associated address tuple is used too long, i.e (?i.e.), longer than for a predetermined duration. This duration could randomly vary within limits that are predetermined by the switching unit. Each new end-to-end communication that is established by the subscriber or network node may use a new address tuple. According to a method described further below, it is likewise possible to use a new address tuple for each end-to-end communication that is established to the subscriber or network node. In this connection, the links of higher layers are not necessarily interrupted.

When too few unused addresses are available at the subscriber or in the network node, and the subscriber or network node requests new addresses from the switching unit, but the transmission of new addresses from the switching unit to the subscriber or network node remains repeatedly unsuccessful—for example, because the switching unit is unreachable—the case may occur that assigned addresses are no longer available. Too few addresses mean, for example, that less than a predetermined quantity of addresses exists. In this case, the predetermined quantity could randomly vary between a maximum and a minimum value that are predetermined by the switching unit. In such a situation, the subscriber or the switching unit may determine whether in this case the subscriber or the network node discontinues service until a new initialization, or whether it continues to use already used addresses.

For a communication between the subscriber or network node and the switching unit, a communicating relation is established respectively between the subscriber or network node and the switching unit. With respect to a high security, it will be in this case of advantage, when the second subscriber or the network node and the switching unit mutually identify and or authenticate themselves within the scope of such a communicating relation. In this connection, it would be possible to use cryptological methods for the identification and/or authentication. In so doing, a data stream could be securely encrypted. To this end, it would be possible to use data that are exchanged, for example, in the authentication. Basically, it would be possible to provide exchanged data with an additional integrity protection. In a thus-protected communicating relation, the subscriber or network node could then request new addresses, for example, local and routing addresses, which could then be safely exchanged.

In a concrete case of establishing a link, the first subscriber could transmit a public address of the second subscriber to the telecommunication network for establishing the link to the second subscriber. However, with this public address the second subscriber is not yet reachable, i.e., the public address is not usable as a routing address.

In a next step, the switching unit could convert the public address into a routing address. The switching unit would then be able to inform the second subscriber about a request of the first subscriber for establishing the link. Within the scope of this information, the switching unit could furthermore transmit a routing address and, if need be, a public address of the first subscriber to the second subscriber. With the public address, the second subscriber will have a possibility of receiving information about the first subscriber.

Should the second subscriber agree with the request of the first subscriber for establishing the link, the switching unit would be able to transmit to the first subscriber—upon this consent of the second subscriber—a routing address and, if need be, an identifier address of the second subscriber. The transmitted routing address and, if need be, an identifier address of the second subscriber could be agreed between the switching unit and the first subscriber and/or between the switching unit and the second subscriber.

On the basis of the transmitted routing address and, if need be, the identifier address of the second subscriber, the first subscriber would then be able to establish a link to the second subscriber. As an alternative thereto, also the second subscriber would be able to establish a link to the first subscriber. In this process, the switching unit would first agree with the first and the second subscriber the routing address and, if need be, the identifier address of the first subscriber.

Within the scope of establishing the link, or within the scope of the link, the first and the second subscriber could authenticate themselves. To this end, the switching unit could have previously transmitted authentication parameters to the first and/or the second subscriber.

With respect to concealing the link or establishment of the link between the first and the second subscriber, individual communication steps could occur between the switching unit and the first and/or the second subscriber and/or between the first and the second subscriber by way of a temporal and/or a causal decoupling. This allows to substantially complicate a tracing of the link establishment or link by unauthorized third parties.

In this connection, it would be possible to conceal individual communication steps between the switching unit and the first and/or the second subscriber and/or between the first and the second subscriber by delays, permutations, or faked transactions. Concretely, the temporal and/or causal decouplings, and/or delays, permutations, faked transactions could occur through the switching unit, and/or the first, and/or the second subscriber.

To avoid a systematic search for data or movements of the second subscriber, the switching unit or the second subscriber could block the first subscriber in further attempts of establishing a link, in the case that a previous attempt of a link establishment has been already rejected by the switching unit or the second subscriber. Such an access rejection could occur temporally or permanently. Basically, attempts of establishing a link by unauthorized subscribers could be blocked temporally or permanently. It could be determined that only subscribed users will be able to communicate.

In an advantageous realization of the telecommunication network, one or more subscribers could have relay functions or operate as relays. In other words, parts of the communication network could have relay functions. In this case, subscribers or network nodes that are subscribed to a provider or the switching unit, function as relays only for such subscribers or network nodes, or use as relays only such subscribers or network nodes that use the same protocols for the relay functionalities. Furthermore, subscribers or network nodes that are subscribed to a provider or the switching unit could function as relays only for such subscribers or network nodes, or use as relays only such subscribers or network nodes that are subscribed to the provider or the switching unit, or to other providers or switching units associated with the provider or switching unit, and which are able to authenticate themselves accordingly.

Furthermore, a predetermined number of subscribers could exchange encoded identifier addresses. It will be especially favorable, when each subscribed network node has exchanged encoded identity addresses with all its subscribed neighbors, i.e., subscribed network nodes that are directly reachable and without intermediate relays. For example, when a network node A wants to use a neighbor X as relay, it will send by the broadcast method a message, which contains neither a routing address nor a local address, but an encoded identity address of X. In case that it is required to include a routing address and/or local address of A, this message may contain such addresses in newly selected form. X may likewise answer with newly selected addresses with reference to the inquiry.

In a further advantageous realization of a telecommunication network, it would be possible to operate from the switching unit a least one gateway to at least one definable subnetwork. In so doing, at least one predetermined subscriber of the subnetwork could use a topological address.

As a whole, the described method will be especially suitable, when the provider or the switching unit also operates gateways to subnetworks, in which each subscriber, user, or network node is reachable from the gateway via a chain of subscribed subscribers or network nodes. This would make it possible to use in the chain topological addresses of subscribed subscribers or network nodes. In this case, the gateway could safely communicate with the switching unit, and both could safely communicate with a location register that is operated by the provider. In a special case, some of these three network nodes could be identical.

When establishing a communicating relation with a subscriber or network node located in such a subnetwork, the establishment of the communication as far as the gateway may occur by the above-described method. In the subnetwork, the topological address information is used. To complicate localizations based on topological address information, it would be possible to apply the following methods:
(A) The at least one predetermined subscriber or network node of the subnetwork, which uses topological addresses, could perform at least one change of coordinates. Likewise other subscribers or network nodes could perform such coordinate changes. In this process, the coordinates would be redundantly available. For the routing, it would then be possible to use only a selection of the coordinates.
(B) For a particularly high security step, the address screening for selecting the coordinates could always occur in the gateway.
(C) A high security could also result, when a topological address or address information that is to be used or screened for establishing a communication, is always transmitted in encoded form. In so doing, at least one predetermined subscriber or network node could include a security module, which performs the decoding of the received topological address or address information, the further processing for selecting the next relay, and the encoding of the topological address information that is to be forwarded. In this connection, it is very essential that the security module be suitable for decoding the encoded topological address. In a suitable manner, it would be possible to protect the security module against invasions, so that it will not be possible to read in plain language text the topological address information that is to be utilized for establishing a communication. In a particularly practically manner, one could use a chip as security module.

All functions of one or more subscribers as described in the present specification could be performed in a particularly reliable manner, preferably automatically by at least one network node, at least one module, or at least one device of one or more network nodes.

When applying the described method in communication networks, one should consider that too frequent changes of the routing address may lead to a significant network load, when, for example, link state protocols—for example OSPF—are used. The method will be applicable in a particularly advantageous manner, when the provider also operates gateways to subnetworks, in which each subscribed network node or subscriber is reachable from the gateway via a chain of subscribed users or network nodes. These may be, for example, WLAN subnetworks, which are basically well attackable.

The method of the invention permits using cryptological functions and methods, such as, for example, methods for encoding, authenticating, and protecting integrity. Special ones of such functions and methods are not described. Rather, it is possible to apply all such suitable functions and methods within the scope of the invention.

Furthermore, within the scope of the present invention mention is made of protocols for the communication between network nodes. The protocols are not described in greater detail. Rather, it is possible to use within the scope of the present invention any protocols, which provide the necessary and suitable functionalities.

Within the scope of the present invention, mention is made in principle of the establishment of a telecommunication link between a first and a second subscriber. The invention is used in particular for protecting confidentiality of addresses and/or identifiers. This could mean an establishment of a telecommunication link as described in the present application, also in the meaning of an establishment in an already existing telecommunication link. This establishment would then be an establishment of a telecommunication link with increased security or increased protection of confidentiality of addresses and/or identifiers, which serves to secure the existing telecommunication link. In this meaning, the establishment of a telecommunication link according to the invention does not necessarily stand for the basic start of a telecommunication link, but also for a kind of upgrade of an existing telecommunication link by a telecommunication link with increased security.

There exist various possibilities of improving and further developing the teaching of the present invention. To this end, one may refer on the one hand to the claims, and on the other hand to the following description of a preferred embodiment of the invention with reference to the drawing. In conjunction with the description of the preferred embodiment of the invention with reference to the drawing, also generally preferred improvements and further developments of the teaching are explained.

### BRIEF DESCRIPTION OF THE DRAWING

The single FIGURE is a schematic view of an embodiment of the method according to the invention for establishing a telecommunication link.

### DETAILED DESCRIPTION OF THE PREFERRED EMBODIMENTS

The drawing FIGURE schematically illustrates a method according to the invention for establishing a telecommunication link between a first subscriber A and a second subscriber BK—user node—in a telecommunication network. The addresses are assignable to subscribers A, BK. With respect to a secure telecommunication link between the subscribers A and BK in the telecommunication network, a switching unit TR—subscriber register—assigns a predetermined number of addresses to the second subscriber BK, before the link is established. The establishment of the link is switched through switching unit TR. When establishing the link, the second subscriber will use at least one of the addresses that are assigned by the switching unit TR.

In a first step, the network node or subscriber A transmits a public address bkö of BK to the telecommunication network. In the described method, it is presumed that the name server associated with bkö—network node—which converts bkö into a routing address, is the subscriber register TR or the switching unit of BK.

In the further process, TR establishes a secure communicating relation to BK, transmits the request of A with regard to establishing the link, if need be, together with further information about A—for example, the routing address and, if available, the public address of A—obtains the consent of BK to transmit a routing address of BK to A, and agrees with BK a routing address bkr that is to be used. In case A is likewise subscribed as BK, TK will transmit authentication parameters to BK. Thereafter, TR transmits bkr to A. If A is also subscribed, TR will use to this end a secured communicating relation and transmits to A authentication parameters, which match with the authentication parameters transmitted to BK. A will then be able to establish a communication to BK, and both may authenticate themselves, if need be. This method is safe, only when A is subscribed. TR or BK may deny a transmission of the routing information or routing address.

As an alternative thereto, BK could also establish a link to A at the request of A to set up a link. In so doing, BK and A could authenticate themselves. Likewise in this instance, TR sets up in a first step a safe communicating relation to BK and transmits the request of A to establish a link, if need be, with additional information about A—for example, the routing address and, if available, the public address of A. In the case that A is likewise subscribed as BK, TK will transmit authentication parameters to BK. This alternative method is likewise safe only, when A is subscribed. TR may deny the transmission of the routing information.

To prevent an attacker from systematically making inquiries to TR for correlating subsequent data streams to BK, TR may block the inquiring network node temporally or permanently for further inquiries after rejecting the first inquiry, and/or block all inquiries from not specially authorized and subscribed network nodes with respect to BK temporally or permanently for further inquiries.

As regards further advantageous improvements and further developments of the teaching according to the invention, the general part of the specification on the one hand and the attached claims on the other hand are herewith incorporated by reference.

Finally, it should be expressly pointed to the fact that the foregoing, merely arbitrarily selected embodiment serves only to explain the teaching of the invention, without however limiting it to this embodiment.

1. A method for establishing a telecommunication link between a first and a second subscriber (A, BK) in a telecommunication network, wherein addresses are assignable to the subscribers (A, BK), and comprising the steps of
providing a switching unit (TR) that assigns to the second subscriber (BK) a predetermined number of addresses before the link is established,
establishing the link by the switching unit (TR), and
using at least one of the assigned addresses by the second subscriber (BK) when the link is established.

2. The method of claim 1, wherein the addresses are anonymous.

3. The method of claim 1 wherein the addresses are managed by the switching unit (TR).

4. The method of claim 1, wherein the addresses are routing and/or local addresses.

5. The method of claim 1, wherein the addresses are IP and/or Ethernet addresses.

6. The method of claim 1, wherein the second subscriber (BK) uses at least one tuple of routing and local addresses.

7. The method of claim 1, wherein the switching unit (TR) is a network node of the telecommunication network.

8. The method of claim 1, wherein the function of the switching unit (TR) is distributed over several network nodes of the telecommunication network.

9. The method of claim 1, wherein the second subscriber (BK) runs an initialization procedure before the link is established.

10. The method of claim 9, wherein within the scope of the initialization procedure, the second subscriber (BK) is provided with functions, parameters, software, firmware, and/or hardware that are necessary for communicating and/or realizing a cryptological function between the second subscriber (BK) and the switching unit (TR).

11. The method of claim 10, wherein the functions, parameters, software, firmware, and/or hardware are installed by the switching unit (TR).

12. The method of claim 9, wherein within the scope of the initialization procedure, the switching unit (TR) assigns to the second subscriber (BK) at least one initial address for at least one type of address before the link is established.

13. The method of claim 9, wherein the switching unit (TR) performs the assignment of the addresses to the second subscriber (BK) within the scope of the initialization procedure.

14. The method of claim 10, wherein at least parts of the parameters, software, and/or firmware are installed on a hardware component.

15. The method of claim 14, wherein the hardware component communicates with the second subscriber (BK) via a definable interface.

16. The method of claim 14, wherein the hardware component is an IC card.

17. The method of claim 1, wherein the second subscriber (BK) removes the used address or addresses from the assignment.

18. The method of claim 1, wherein the second subscriber (BK) requests new addresses from the switching unit (TR) as soon as the number of the addresses that are still available to the second subscriber (BK) are used up or fall below a predetermined quantity.

19. The method of claim 18, wherein the quantity is predetermined by the switching unit (TR).

20. The method of claim 1, wherein the assignment of the addresses occurs within the scope of a secured link.

21. The method of claim 1, wherein the second subscriber (BK) changes the used address or addresses within the scope of its activation.

22. The method of claim 1, wherein the second subscriber (BK) changes the used address or addresses after completing the communication.

23. The method of claim 1, wherein the second subscriber (BK) changes the used address or addresses within the scope of its transition from the connected to the disconnected state.

24. The method of claim 1, wherein the second subscriber changes the used address or addresses after a predetermined time interval.

25. The method of claim 1, wherein within the scope of changing the used address or addresses after a predetermined time interval, the second subscriber (BK) switches, before the change, to the disconnected state.

26. The method of claim 1, wherein within the scope of the link, the second subscriber (BK) uses a plurality of addresses or tuples of addresses at the same time.

27. The method of claim 1, wherein within the scope of a communicating relation, the second subscriber (BK) and the switching unit (TR) mutually identify and/or authenticate themselves.

28. The method of claim 27, wherein cryptological methods are used for identifying and/or authenticating.

29. The method of claim 1, wherein for establishing the link to the second subscriber (BK), the first subscriber (A) transmits to the telecommunication network a public address of the second subscriber (BK).

30. The method of claim 29, wherein the switching unit (TR) converts the public address into a routing address.

31. The method of claim 1, wherein that the switching unit (TR) informs the second subscriber (BK) about a request of the first subscriber (A) for establishing the link.

32. The method of claim 1, wherein the switching unit (TR) transmits to the second subscriber (BK) a routing address and/or a public address of the first subscriber (A).

33. The method of claim 1, wherein upon consent of the second subscriber (BK), the switching unit (TR) transmits a routing address of the second subscriber (BK) to the first subscriber (A).

34. The method of claim 33, wherein the transmitted routing address of the second subscriber (BK) is agreed with the switching unit (TR).

35. The method of claim 33, wherein on the basis of the transmitted routing address of the second subscriber (BK), the first subscriber (A) establishes a link to the second subscriber (BK).

36. The method of claim 1, wherein second subscriber (BK) establishes a link to the first subscriber (A).

37. The method of claim 1, wherein the first and the second subscriber (A, BK) authenticate themselves.

38. The method of claim 1, wherein the switching unit (TR) transmits authentication parameters to the first and/or the second subscriber (A, BK).

39. The method of claim 1, wherein individual communication steps between the switching unit (TR) and the first and/or second subscriber (A, BK) and/or between the first and the second subscriber (A, BK) occur by way of a temporal and/or a causal decoupling.

40. The method of claim 1, wherein individual communication steps between the switching unit (TR) and the first and/or the second subscriber (A, BK) and/or between the first and the second subscriber are concealed by delays, permutations, or faked transactions.

41. The method of claim 40, wherein the chronological and/or causal decouplings, and/or the delays, permutations, or faked transactions occur through the switching unit (TR) and/or through the first and the second subscriber (A, BK).

42. The method of claim 1, wherein the switching unit (TR) or the second subscriber (BK) will block the first subscriber (A) for further attempts of establishing the link, if a previous attempt of establishing the link has already been rejected by the switching unit (TR) or the second subscriber (BK).

43. The method of claim 42, wherein the access rejection occurs temporally or permanently.

44. The method of claim 1, wherein attempts of establishing a link by unauthorized subscribers are blocked temporarily or permanently.

45. The method of claim 1, wherein one or more subscribers have relay functions or operate as relays.

46. The method of claim 1, wherein a predetermined number of subscribers exchange encoded identity addresses.

47. The method of claim 1, wherein at least one gateway to at least one definable subnetwork is operated from the switching unit (TR).

48. The method of claim 47, wherein at least one predetermined subscriber of the subnetwork uses a topological address.

49. The method of claim 48, wherein the at least one predetermined subscriber of the subnetwork performs at least one change of coordinates.

50. The method of claim 48, wherein the topologial address is transmitted in encoded form.

51. The method of claim 48, wherein at least one predetermined subscriber has a security module for decoding the encoded topological address.

52. The method of claim 51, wherein the security module is a chip.

53. The method of claim 1, wherein the function of one or more subscribers is performed, preferably automatically by at least one network node, at least one module, or at least one device of one or more network nodes.

54. A telecommunication network for establishing a telecommunication link between a first and a second subscriber (A, BK) to which addresses may be assigned, and comprising a switching unit (TR) which is configured to assign to the second subscriber (BK) a predetermined number of addresses before the link is established and to then establish the link, and wherein the second subscriber (BK) is configured to use at least one of the assigned addresses when the link is established.
